(19) United States
(12) Patent Application Publication
(10) Pub. No.: US 2015/0076757 A1
(43) Pub. Date: Mar. 19, 2015

(54) SYSTEM FOR SECURING TWO COMPONENTS

(71) Applicant: Caterpillar Inc., Peoria, IL (US)

(72) Inventors: Stephen A. Shula, Yorkville, IL (US); Mark J. Thompson, Virgil, IL (US); Piotr Gadek, Naperville, IL (US)

(73) Assignee: Caterpillar Inc., Peoria, IL (US)

(21) Appl. No.: 14/548,316

(22) Filed: Nov. 20, 2014

(51) Int. Cl. B25B 11/00; B25B 5/14; B23K 37/04; B25B 5/12

(52) U.S. Cl. CPC B25B 11/002; B25B 5/127; B25B 5/145; B23K 37/0435
USPC 269/95

(57) ABSTRACT

A system for detachably securing a first component to a metallic surface of a second component is provided. The system includes a magnetic device, a bracket member, and a clamping device. The magnetic device is configured to selectively generate a magnetic force for securing the magnetic device to the metallic surface of the second component. The bracket member includes a first portion coupled to the magnetic device, and a second portion offset with respect to the first portion. The clamping device includes a support member, a rod member, a spindle member and a latch. The support member is coupled to the second portion of the bracket member. The latch is configured for selectively moving the rod member and the spindle member so that a tip of the spindle member is moved into contacting engagement with the first component for securing the first component to the surface of the second component.

### TECHNICAL FIELD

The present disclosure relates to a system for detachably securing a first component to a surface of a second component.

### BACKGROUND

Two components may be secured to each other for carrying out various joining operations, such as adhesive bonding, welding, brazing, and the like. For example, two components that are joined by an adhesive have to be secured to each other for a predetermined time to enable the adhesive to harden and form the adhesive bond. Typically, the components are secured to each other by tape. However, application and removal of the tape be time consuming Further, tape may not be suitable for various types of components.

For reference, U.S. Pat. No. 4,300,754 (the '754 patent) discloses a clamp for holding work pieces in assembled relationship for welding and the like. The clamp includes a pair of discrete posts and a transverse member, as fabricated preferably of bar stock. Each of the pair of posts pivotally mounts a magnet at the lower end thereof and cooperative interengagement expedients are provided on the posts and transverse member to permit of interengagement in preselected relationship. A threaded hold-down member is adapted for mounted disposition upon the transverse member in predetermined relationship thereto.

### SUMMARY OF THE DISCLOSURE

In one aspect of the present disclosure, a system for detachably securing a first component to a metallic surface of a second component is provided. The system includes a magnetic device, a bracket member coupled to the magnetic device and a clamping device. The magnetic device is configured to selectively generate a magnetic force for securing the magnetic device to the metallic surface of the second component. The bracket member includes a first portion coupled to the magnetic device, and a second portion offset with respect to the first portion. The clamping device includes a support member, a sleeve member, a rod member, a spindle member and a latch. The support member is coupled to the second portion of the bracket member. The sleeve member is coupled to the support member. A rod member is slidably received within the sleeve member. The spindle member is coupled to the rod member and includes a tip. Further, the rod member and the spindle member together define a longitudinal axis. The latch is movably coupled to the support member and the rod member. The latch is configured for selectively moving the rod member and the spindle member along the longitudinal axis relative to the sleeve member so that the tip of the spindle member is moved into contacting engagement with the first component for securing the first component to the metallic surface of the second component.

Other features and aspects of this disclosure will be apparent from the following description and the accompanying drawings.

### BRIEF DESCRIPTION OF THE DRAWINGS

FIG. 1 illustrates a perspective view of an exemplary assembly having a first component secured to a second component;

FIG. 2 illustrates a perspective view of a system for securing the first component to the second component, according to an embodiment of the present disclosure;

FIG. 3 illustrates a perspective view of the system of FIG. 2 in a clamped configuration; and

FIG. 4 illustrates a perspective view of the assembly of FIG. 1 with the system in an unclamped configuration.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

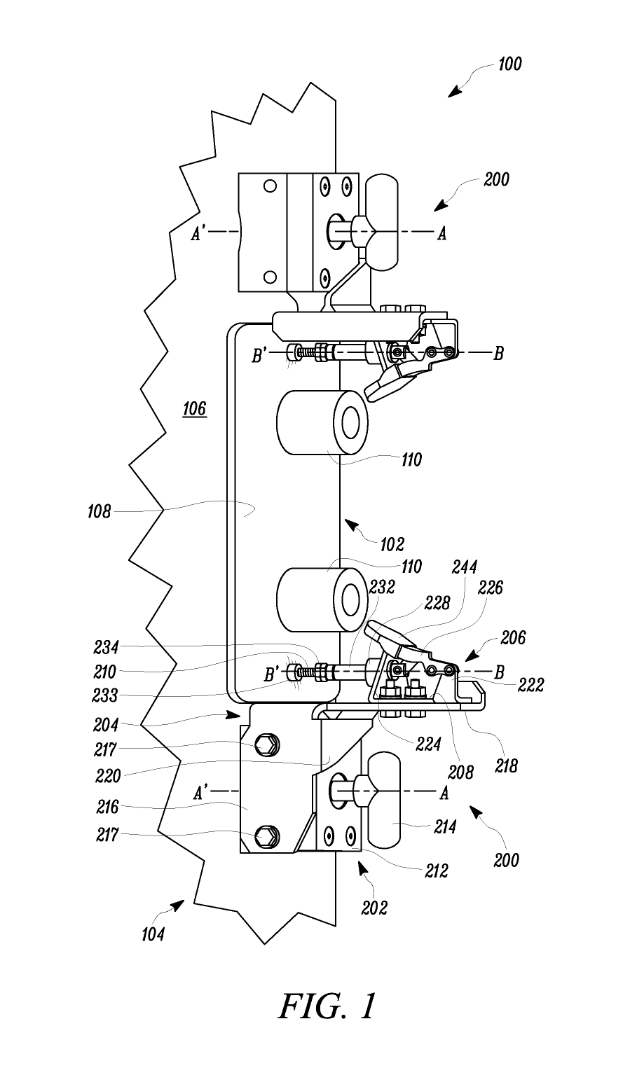

FIG. 1 shows a perspective view of an exemplary assembly 100 having a first component 102 secured to a second component 104. In an example, the second component 104 may be a part of an operator cab of a machine. The machine may be, for example, an excavator, a dozer, a grader, a mining truck, and the like. The second component 104 includes a metallic surface 106 on which the first component 102 is disposed. The metallic surface 106 may be made of a paramagnetic or ferromagnetic material. The first component 102 may be made of a metal or metallic alloy, a plastic, a composite, and the like. The first component 102 includes a base portion 108 and two bosses 110 extending from the base portion 108. The bosses 110 may be threaded for attachment to one or more accessories or aftermarket products. The first component and second components 102, 104, as shown in FIG. 1, are purely exemplary in nature, and alternative designs may be contemplated without departing from the scope of the present disclosure. For example, the first component 102 may include any number of bosses 110 as per requirements.

The base portion 108 may be attached to the metallic surface 106 of the second component 104 via an adhesive. However, the first component 102 and the second component 104 may have to be secured to one other under pressure for a predetermined duration to enable the adhesive to harden and form the adhesive bond. As shown in FIG. 1, a system 200 detachably secures the first component 102 to the second component 104. It may also be contemplated that the system 200 may secure the first component 102 to the second component 104 for any other process, for example, welding, brazing, soldering, or any other joining process known in the art. The system 200 is described hereinafter in detail.

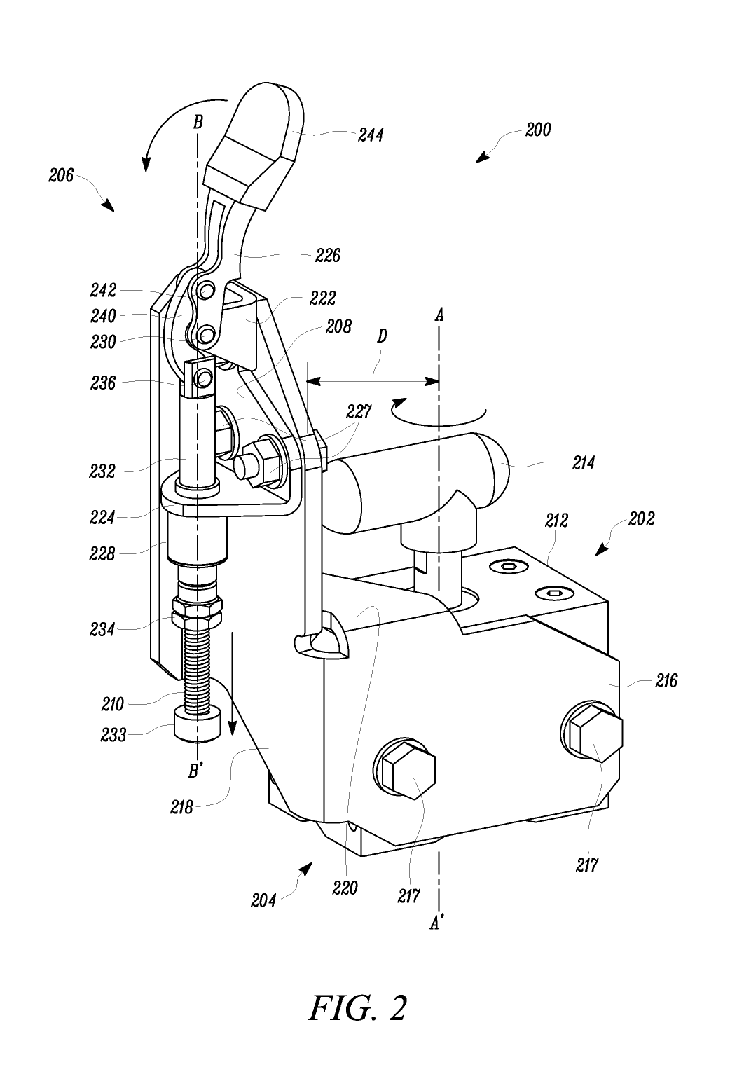

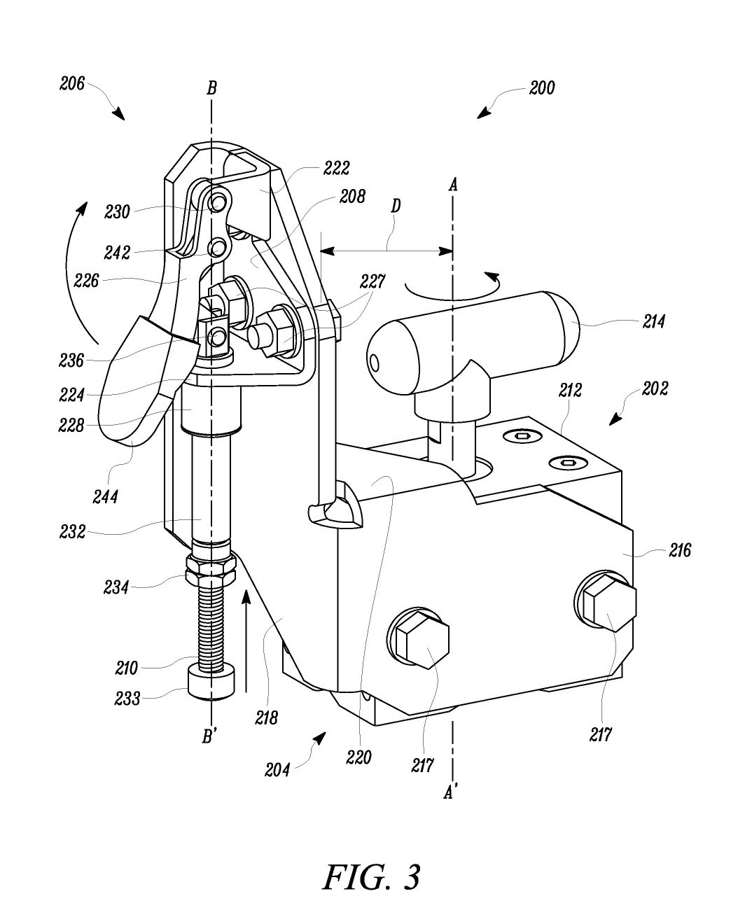

FIGS. 2 and 3 illustrate perspective views of the system 200, according to an embodiment of the present disclosure. Reference may also be made to FIG. 1 to describe one or more components of the system 200. The system 200 includes a magnetic device 202, a bracket member 204 coupled to the magnetic device 202, and a clamping device 206 coupled to the bracket member 204. The magnetic device 202 includes a housing 212, a handle 214 extending from the housing 212 and one or more magnets (not shown) provided within the housing 212. In an embodiment, the magnets may be permanent magnets made of a ferromagnetic material or a rare earth material. In an alternative embodiment the magnets may be electromagnets. The magnetic device 202 is configured to selectively generate a magnetic force for securing the magnetic device 202 to the metallic surface 106 of the second component 104. The handle 214 may be rotatable about a rotation axis A-A′ between an inactive position (shown in FIG. 2) and an active position (shown in FIG. 3). In the inactive position of the handle 214, the magnetic device 202 may not generate an external magnetic field and may be movable with respect to the metallic surface 106. In the active position, the magnetic device 202 may generate an external magnetic field so that the magnetic device 202 may be secured to the metallic surface 106. Hence, the magnetic device 202 may detachably secure the system 200 to the metallic surface 106. In an embodiment, the rotation of the handle 214 may move the one or more magnets within the housing 212 such that an external magnetic field may be selectively generated. In an example, the magnetic device 202 may be a “Magswitch Magsquare” manufactured by Magswitch®.

Further, the bracket member 204 includes a first portion 216, a second portion 218 and a third portion 220. Multiple fasteners 217 couple the first portion 216 of the bracket member 204 to the magnetic device 202. The first portion 216 of the bracket member 204 and the housing 212 of the magnetic device 202 define corresponding apertures for receiving the fasteners 217. In the illustrated embodiment, the fasteners 217 may be bolts. However, in various alternative embodiments, the first portion 216 and the magnetic device 202 may be coupled by screws, welding, adhesives etc. The second portion 218 extends from the first portion 216. Further, the second portion 218 is at an offset with respect to the first portion 216. As illustrated in FIGS. 2 and 3, the second portion 218 may be offset from the rotation axis A-A′ by a distance ‘D’. Further, the second portion 218 may be substantially perpendicular with respect to the first portion 216. The third portion 220 is coupled to the first portion 216 and the second portion 218. The third portion 220 may extend on an upper surface of the housing 212 of the magnetic device 202 such that a relative movement between the bracket member 204 and the magnetic device 202 may be minimized.

Further, the clamping device 206 is coupled to the bracket member 204. The clamping device 206 includes a support member 208, a sleeve member 228, a rod member 232, a spindle member 210 and a latch 226. The support member 208 is coupled to the second portion 218 of the bracket member 204 via fasteners 227. The support member 208 and the second portion 218 define corresponding apertures for receiving the fasteners 227. In the illustrated embodiment, the fasteners 227 are nut and bolt assemblies. However, in various alternative embodiments, the second portion 218 may be coupled to the support member 208 via screws, welding, adhesives, and the like. Moreover, the support member 208 includes a first extension 222 and a second extension 224. A first pin joint 230 pivotally couples the latch 226 to the first extension 222. The sleeve member 228 is coupled to the second extension 224. The sleeve member 228 may be a hollow cylinder. Further, the rod member 232 is slidably received within the sleeve member 228. The second extension 224 also defines an aperture for receiving the rod member 232 therethrough. One or more bushings may be disposed within the aperture of the second extension 224 and the sleeve member 228 to facilitate a sliding motion of the rod member 232. Moreover, a second pin joint 236 pivotally couples one end of the rod member 232 to a link 240. A third pin joint 242 pivotally coupled the link 240 to the latch 226. Hence, the latch 226 is movably coupled to the support member 208. Further, the latch 226 is movably coupled to the rod member 232 via the link 240.

The spindle member 210 is coupled to the rod member 232. The spindle member 210 also extends from an end of the rod member 232 distal to the second pin joint 236. The rod member 232 and the spindle member 210 together define a longitudinal axis B-B′. The spindle member 210 is a threaded member with a tip 233 disposed at one end thereof. A length of the spindle member 210 extending from the rod member 232 may be adjusted by loosening a pair of lock nuts or jam nuts 234.

The latch 226 may be configured to selectively move the rod member 232 and the spindle member 210 along the longitudinal axis B-B′ with respect to the sleeve member 228. Specifically, the latch 226 may be moved in order to switch the clamping device 206 between an unclamped configuration (shown in FIG. 2) and a clamped configuration (shown in FIG. 3). In FIG. 2, the latch 226 may be disposed at an upper pivotal limit with respect to the support member 208. In FIG. 3, the latch 226 may be moved to a lower pivotal limit with respect to the support member 208. The latch 226 also includes a gripping portion 244 to facilitate manual gripping of the latch 226. The latch 226 moves the link 240 which in turn moves the rod member 232 and the spindle member 210 along the longitudinal axis B-B′ with respect to the sleeve member 228. The tip 233 of the spindle member 210 may therefore also move along the longitudinal axis B-B′. With reference to FIG. 1, the tip 233 may be moved into contacting engagement with the first component 102 for securing the first component 102 to the metallic surface 106 of the second component 104.

### INDUSTRIAL APPLICABILITY

The present disclosure relates to the system 200 for removably securing two components for carrying out a joining process between the two components. The joining process may include adhesive bonding, welding, brazing, soldering, and the like. An exemplary operation of the system 200 will be described hereinafter with reference to FIGS. 1 to 4

In the illustrated embodiment, the first component 102 is coupled to the metallic surface 106 of the second component 104 via an adhesive. The system 200 may secure the first component 102 to the metallic surface 106 for a predetermined time to enable the adhesive to harden and form the adhesive bond. The first component 102 may be used for attachment of one or more accessories or aftermarket products. However, the system 200 may also used to secure two components during any manufacturing process.

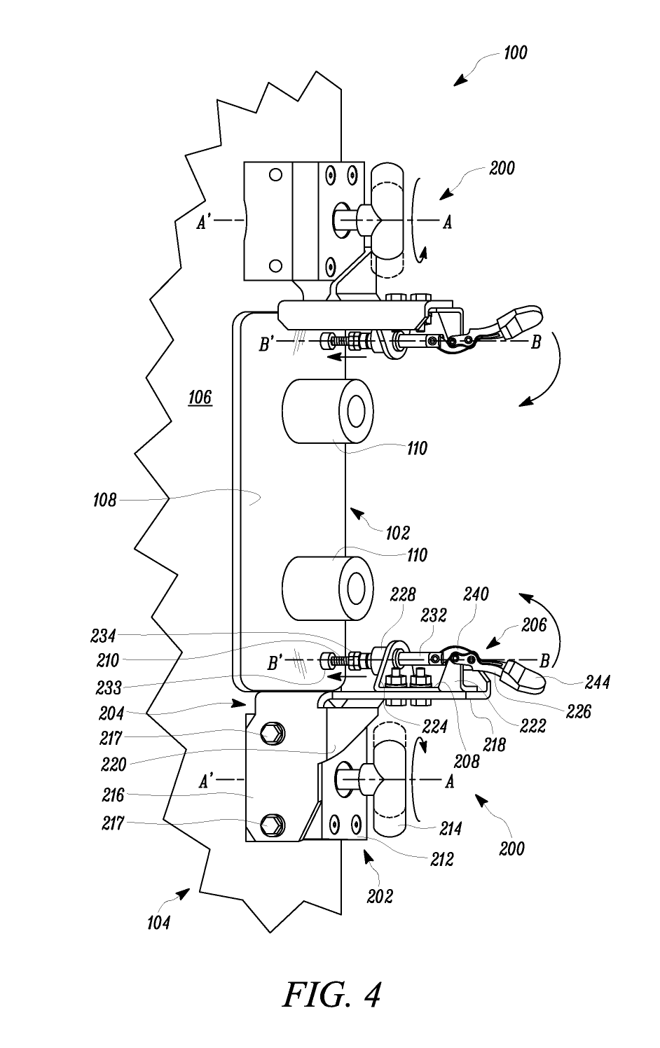

In order to secure the first component 102 to the metallic surface 106 via the system 200, a user may first place the magnetic device 202 on the metallic surface 106 adjacent to the first component 102 such that the spindle member 210 is disposed above the first component 102, as shown in FIG. 4. Initially, the handle 214 of the magnetic device 202 may be in the inactive position. Further, the clamping device 206 may be in the unclamped configuration. The user may rotate the handle 214 of the magnetic device 202 from the inactive position to the active position so that the magnetic device 202 is secured to the metallic surface 106 by a magnetic force. The user may then move the latch 226 from the upper pivotal limit to the lower pivotal limit so that the tip 233 of the spindle member 210 is moved into contacting engagement with the first component 102, as shown in FIG. 1. Hence, the clamping device 206 may press the first component 102 against the metallic surface 106 with a clamping force in order to facilitate the formation of adhesive bond.

After a predetermined time, the user may move the latch 226 to the upper pivotal limit such that the clamping device 206 is in the unclamped configuration. The user may then rotate the handle 214 from the active position to the inactive position. The magnetic device 202 may be then lifted from the metallic surface 106. Though two systems 200 are illustrated in FIGS. 1 and 4, it may be contemplated that any number of systems 200 may be used as per requirements.

The magnetic device 202 may enable fast attachment and removal of the system 200 from the metallic surface 106. Further, an amount of clamping force on the first component 102 may be adjusted by changing a length of the spindle member 210 extending from the rod member 232. The spindle member 210 may also be adjusted for various dimensions of the first component 102. The bracket member 204 may further provide a compact arrangement for the system 200. Adjustability of the spindle member 210 and the compact arrangement may enable the system 200 to be used in various applications. Multiple such systems 200 may also be simultaneously used as per clamping requirements.

Moreover, an orientation of the second portion 218 of the bracket member 204 with respect to the first portion 216 may minimize the distance ‘D’ between the second portion 218 and the rotation axis A-A′. Hence, a distance between the longitudinal axis B-B′ and the rotation axis A-A′ may be minimized, thereby reducing a moment due to a clamping force exerted by the clamping device 206. Reduction in moment may retain the system 200 in a stationary position with greater stability.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for detachably securing a first component to a metallic surface of a second component, the system comprising:
a magnetic device configured to selectively generate a magnetic force for securing the magnetic device to the metallic surface of the second component;
a bracket member coupled to the magnetic device, the bracket member comprising:
a first portion coupled to the magnetic device; and
a second portion offset with respect to the first portion; and
a clamping device, the clamping device comprising:
a support member coupled to the second portion of the bracket member;
a sleeve member coupled to the support member;
a rod member slidably received within the sleeve member;
a spindle member coupled to the rod member and including a tip, the rod member and the spindle together defining a longitudinal axis; and
a latch movably coupled to the support member and the rod member, the latch configured for selectively moving the rod member and the spindle member along the longitudinal axis relative to the sleeve member so that the tip of the spindle member is moved into contacting engagement with the first component for securing the first component to the metallic surface of the second component.
